(19) United States
(12) Patent Application Publication
(10) Pub. No.: US 2007/0070042 A1
(43) Pub. Date: Mar. 29, 2007

(54) Control system and method for controlling a keyboard-video-mouse (KVM) switch

(75) Inventors: Chin-chou Lin, Si jhih City (TW); Yung-ping Lin, Si jhih City (TW); Chi-ming Lo, Si jhih City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Aten International Co., Ltd.

(21) Appl. No.: 11/237,516

(22) Filed: Sep. 28, 2005

(51) Int. Cl. G09G 5/00

(52) U.S. Cl. 345/168

(57) ABSTRACT

A control system for controlling a keyboard-video-mouse (KVM) switch interconnecting among at least one set of keyboard, video, mouse of a console and a plurality of computers comprises a first memory and at least one embedded module. The first memory stores a plurality of control instructions to control operational signals for the keyboard-video-mouse switch. The embedded module comprises a core unit, a second memory and a decoder. The core unit executes the control instructions fetched from the first memory to control the keyboard, video, mouse signals from or to the keyboard-video-mouse switch. The second memory is accessed by the core unit to load and store at least an operational signal through a communication among the console and the computers. The decoder coupled to the core unit and the first memory respectively decodes the control instructions stored in the first memory.

### FIELD OF THE INVENTION

The present invention generally relates to a control system and method for controlling a keyboard-video-mouse (KVM) switch, and more particularly to a control system and method for controlling a KVM switch interconnecting among at least one set of keyboard, video, mouse of a console and a plurality of computers.

### BACKGROUND OF THE INVENTION

As well known, a keyboard-video-mouse (KVM) switch interconnecting a console and a plurality of computers is utilized as an interface to transmit KVM signals therebetween. Accordingly, the user can remotely control the selected computers at the console. Even though with the rapid development of network engineering, a keyboard-video-mouse (KVM) switch still remains at a typical management application, while more and more computers are linked increasingly, to merely provide the user with remote control for the linked computers. Most of those KVM switches have a daisy chain and cascade with each other, so the numbers of interconnected computers with one console can reach even thousands.

Currently, various kinds of specific IC chip designs functioning as a single chip computer of called “chip8051” have been gradually developed and commonly utilized as a part of a keyboard-video-mouse (KVM) switch because it will save the research and development cost of the related hardware. The single chip computer (e.g.chip8051) is one of kinds of system on chip (SoC), which is embedded with Flash ROM. Any developer only needs to care about adaptation of program to such a chip nearly without considering the hardware related problems. It means that the developer will just load proper control programs into the chip, and then performs a ready-made tester to simulate several operational situations for debugging. However, the fabrication of the single chip computer still costs higher upon a higher-cost semiconductor-process that has a complexity of integrating the logic circuit and Flash ROM and a poor yield problem. Consequentially, the chip is not a full-customizable design due to the Flash ROM embedded inside. If the KVM switch producer would like to employ such a chip to make a KVM switch, they must additionally create a circuitry system, e.g. a print circuit board, to incorporate the chip, and can't encode the related software programs. In other words, any person skilled in this field of the art can easily understand the whole conception by interpreting from the print circuit board and accessing the un-encoded software programs from the chip embedded with Flash ROM.

Furthermore, the KVM switch should be developed in adaptation of different data transmission standards, i.e. Internet Protocol, USB, PS/2 . . . etc. With regard to the different data transmission standards, the KVM switch producer may need to individually implement the research and development. While more and more computers are being linked with various kinds of KVM switch systems via the network increasingly, the KVM switch system must have a capability of interconnecting those computers with different data transmission standards on control demands. Therefore, for KVM industry, there is a significant topic to develop a micro KVM switch system in compliance with various kinds of data transmission standards, for providing a more convenient operation and a lower equipment cost.

### SUMMARY OF THE INVENTION

To solve the foregoing drawbacks of the prior art, it is a primary object of the present invention to provide a control system and method for controlling a keyboard-video-mouse (KVM) switch, capable of keeping the design information of the KVM switch confidential and customizing the KVM switch actively on demands.

Another object of the present invention is to provide a control system and method for controlling a keyboard-video-mouse (KVM) switch to be complied with various kinds of data transmission standards.

To achieve the above objects, the present invention provides a control system for controlling a keyboard-video-mouse switch interconnecting among at least one set of keyboard, video, mouse of at least one console and a plurality of computers. The control system comprises a first memory and at least one embedded module. The first memory stores the control instructions to control operational signals for the keyboard-video-mouse switch. The embedded module comprises a core unit, a second memory and a decoder, wherein the core unit executes the control instructions fetched from the first memory to control the keyboard, video, mouse signals from or to the keyboard-video-mouse switch. The second memory is accessed by the core unit to load or store at least an operational signal as a buffer through a communication among the console and the computers. The decoder coupled to the core unit and the first memory respectively decodes the control instructions stored in the first memory. Particularly, the decoder further includes an encoding mechanism used for the reversing process of that control instructions fetched by the core unit. Selectively, the first memory also could be embedded into the embedded module as long as to keep the control instructions encoded for data security.

Meanwhile, the embedded module comprises a host controller unit with a root hub unit, at least one device controller unit, at least one hub unit, a video processor unit, at least one general purpose input and output (GPIO) unit, at least one inter-integrated circuit (I₂C) unit. Those control units which are described above are designed into the embedded module to increase functions of the control system for controlling a keyboard-video-mouse switch and with the same reason that these previous functional designs in the print board have been embedded into the embedded module, as the system on chip (SoC), the claimed invention can promote the performance of the keyboard-video-mouse switch and save more power. Further, the first memory comprises a first storage block and a second storage block wherein the first storage block is used to store the control instructions and the second storage block is used to store upgrade instructions. Through a further embedded serial transmission port control unit coupled to the core unit, the claimed invention is capable to download encoded new control instructions into the first storage block by executing the upgrade instructions stored in the second storage block to also keep design information of the KVM switch confidential.

Furthermore, the embedded module can be set at either a master mode or slave mode whereby an embedded module with slave mode can be controlled by the other embedded module with master mode or an added control process unit (CPU). The purpose to set the embedded modules at a master mode or a slave mode is to increase the numbers of device controller units to connect more computers (e.g. each embedded module has four device controller units. One embedded module with master mode is connected with another embedded module with slave mode, eight device controller units will be used, i.e. numbers of control capacity is up to eight computers). When an added control process unit (CPU) is used to control at least one embedded module, exception for use of more device controller units, the design compatibility of the KVM switches complied with various kinds of transmission data standards (e.g. at least one USB standard embedded module with slave mode controlled by the added control process unit (CPU), the signals can be sent out of KVM switch over IP.). Consequentially, the claimed invention can provide the design compatibility of the KVM switches complied with various kinds of data transmission standards.

Beside, a method of performing a control system for controlling a KVM switch interconnecting among at least one set of keyboard, video, mouse of a console, and a plurality of computers is described below:

Initializing the control system by the embedded module;

The embedded module detecting whether the at least one set of keyboard, video, mouse of a console, a plurality of computers, and maybe several peripherals alive or not; and

transferring at least an operational signal among at least one set keyboard, video, mouse of at least one console, a plurality of computers and maybe several peripherals.

The initializing step further comprises the step:

communicating with the decoder by the core unit;

decoding instructions from the first memory by the decoder; and

recognizing the control system according to the decoded instructions accessed from the first memory by the embedded module.

The transferring step further comprises the step:

making at least one path between specific set of keyboard, video, mouse of the specific console, specific computers and specific peripherals according to the command from the specific console; and

delivering or receiving the at least an operational signal from or to the specific set keyboard, video, mouse of the specific console, the specific computers and the specific peripherals simultaneously using the second memory as a buffer according the path.

The advantages of the proposed invention is to provide a control system and method for controlling a keyboard-video-mouse switch that the single chip computer thereof is not embedded with Flash ROM inside to encode the software instructions so that the design of the keyboard-video-mouse switch can be customized actively and the design of the proposed control system and method is able to be complied in accordance with all kinds of transmission data specifications.

### BRIEF DESCRIPTION OF THE DRAWINGS

The foregoing aspects and many of the attendant advantages of this invention will become more readily appreciated as the same becomes better understood by reference to the following detailed description when taken in conjunction with the accompanying drawings, wherein:

FIG. 1 illustrates an active block diagram of a USB-type keyboard-video-mouse (KVM) switch applied in a control system according to the present invention, interconnecting with one set of keyboard, video, mouse of one console, one computer and one peripheral.

FIG. 2 illustrates a detailed block diagram of an embedded module applied in a control system according to the present invention, for controlling a keyboard-video-mouse (KVM) switch.

FIG. 3 illustrates a block diagram of a control system for controlling a keyboard-video-mouse (KVM) switch, according to the present invention.

FIG. 4 shows a flow chart of the method to perform a control system for controlling a keyboard-video-mouse (KVM) switch, according to the present invention.

### DETAILED DESCRIPTION OF THE PREFERRED EMBODIMENTS

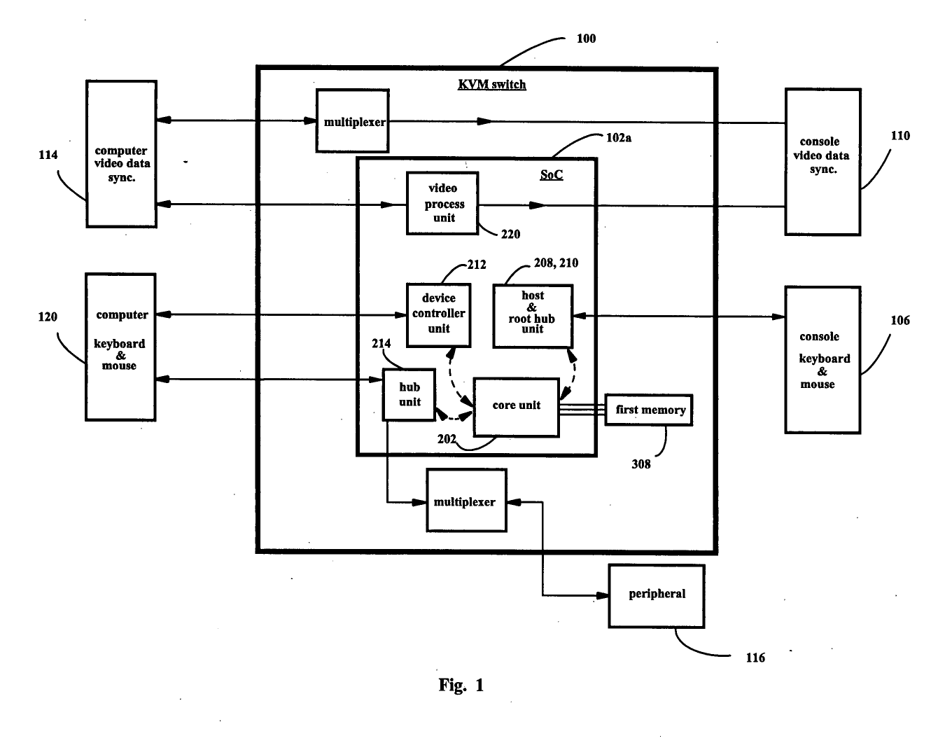

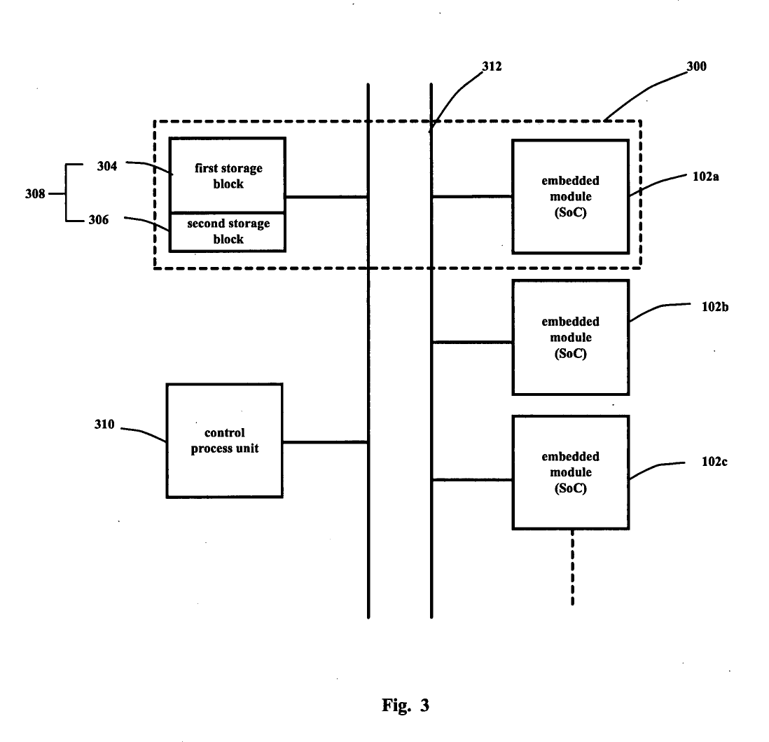

Firstly referring to a block diagram illustrated in FIG. 3, a control system 300 according to a preferred embodiment of the present invention is presented for controlling a keyboard-video-mouse (KVM) switch 100 (see FIG. 1). The control system 300 includes an embedded module (SoC) 102a, and a first memory 308 which is constituted by a first storage block 304 and a second storage block 306 wherein the first storage block 304 is used to store a plurality of control instructions, and the second storage block 306 is used to store a plurality of upgrade instructions. The bus 312 is as a channel to transmit data from the control system 300 to the KVM switch.

Furthermore, any one of the embedded modules (SoC) 102a, 102b, 102c in a main system in FIG. 3 can be set at either a master mode or slave mode. For example, each embedded module (SoC) 102a, 102b, 102c has four device controller units. When the embedded module (SoC) 102a set with master mode is connected with another embedded module 102b in slave mode, eight device controller units will be used, i.e. numbers of control capacity is up to eight computers. Moreover, When the embedded module (SoC) 102a in master mode is connected with the other two embedded module (SoC) 102b, 102c in slave modes, twelve device controller units will be used, i.e. control capacity for the devices of which numbers is up to twelve computers. When an added control process unit (CPU) is used to connect the three embedded modules 102a, 102b, 102c in slave mode, as showed in the FIG. 3, exception for use of twelve device controller units, the design compatibility of the KVM switches complied with various kinds of data transmission standards can be achieved. For instance, a control system for controlling a KVM switch complied with various kinds of data transmission standards, has a control capacity for the computers of which numbers can be up to twelve computers, depending on the standard of the added control process unit (CPU). If the three embedded module (SoC) 102a, 102b, 102c meets USB specification and are controlled with slave modes by the control process unit (CPU) 110, the signals can be sent out of KVM switch over IP.

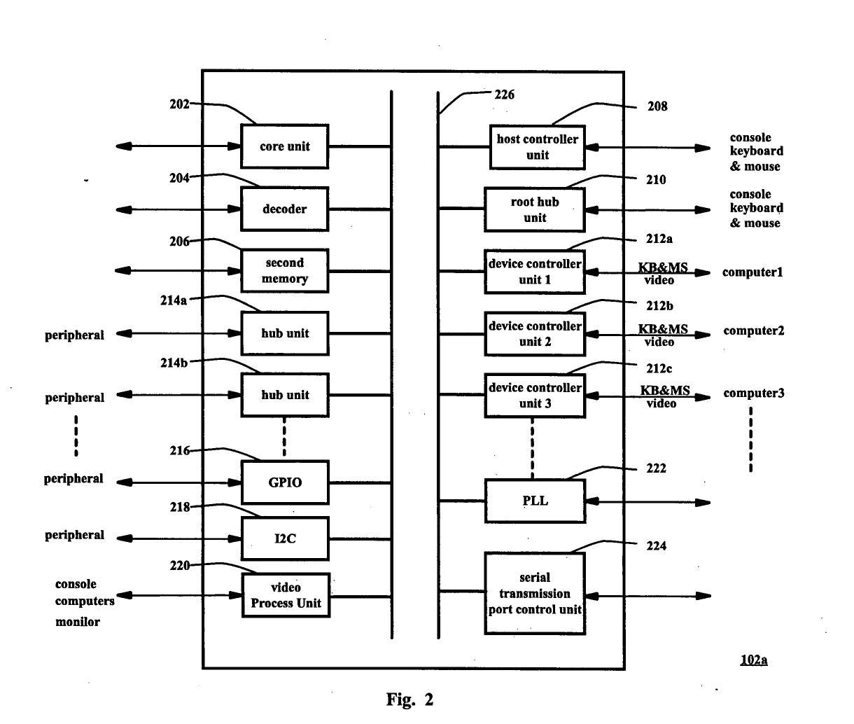

Further referring to an active block diagram illustrated in FIG. 1, the keyboard-video-mouse (KVM) switch 100 controlled by the control system 300 (see FIG. 3) interconnects with one set of keyboard, video, mouse of a console, a computer and a peripheral. The embedded module (SoC) 102a of the control system 300 (see FIG. 3) is realized as a system on chip to control the KVM switch 100. Through a host and root hub unit 208, 210, the embedded module (SoC) 102a can be connected with a set of keyboard and mouse of the console 106 to delivers or receives at least an operational keyboard or mouse signal from or to the set of keyboard & mouse of the console 106. Through a video processor unit 220 (see FIG. 2), disposed within the embedded module (SoC) 102a, the embedded module (SoC) 102a can be connected with a video data sync. (i.e. monitors) of the console 110 to delivers at least an operational video signal to the video data sync. (i.e. monitors) of the console 110.

On the other way, through a device controller unit 212, the embedded module (SoC) 102a can be connected with the computers 120 to deliver or receive at least an operational keyboard or mouse signal from or to the computers 120. Through video processor unit 220 (see FIG. 2), the embedded module 102a can be connected with a video data sync. of the computer 114 to deliver or receive at least an operational video signal from or to the video data sync. of the computer 114. Occasionally or even usually, the peripherals might be used for some purpose. And, through a hub unit 214, the embedded module (SoC) 102a can be connected with the peripherals to deliver or receive at least an operational signal from or to the peripheral. In FIG. 1, a multiplexer is commonly used for transmitting lot of signals between the console 110 and computer 114.

Please refer to a detailed block diagram of the embedded module 102a illustrated in FIG. 2. The embedded module 102a is applied for control of the control system 300 shown in FIG. 3 to a keyboard-video-mouse (KVM) switch, and primarily includes a core unit 202, a decoder 204, a second memory 206, the host controller 208 with the root hub unit 210, the plurality of device controller unit 1, 2, 3 . . . , (212a, 212b, 212c . . . ), the plurality of hub unit 1, 2, 3 . . . (214a, 21b, 214c . . . ), a general purpose input and output (GPIO) unit 216, an Inter-integrated circuit (I₂C) unit 218, the video process unit 220, a phase lock loop (PLL) 222, and a serial transmission port control unit 224 and a bus 226. The core unit 202 executes the control instructions fetched from the first memory 308 (see FIG. 3) to control the keyboard, video, or mouse signal from or to the keyboard-video-mouse switch. The second memory 206 is accessed by the core unit 202 to load or store at least an operational signal through a communication among the console and the computers, i.e. a buffer of the data transmission. The decoder 204 coupled to the core unit 202 and the first memory 308 (shown in FIG. 3) outside the embedded module 102a respectively decodes the control instructions from the first memory 308 shown in FIG. 3. Particularly, the decoder 204 may further include an encoding mechanism used for reversing process of the control instructions fetched by the core unit 202. Therefore, the control instructions stored in the first memory 308 can be encoded for data security. Selectively, the first memory 308 also could be embedded into the embedded module 102a.

While the host controller 208 with the root hub unit 210, the device controller unit 1, 2, 3 . . . ., (212a, 212b, 212c . . . ) and the hub unit 1, 2, 3 . . . (214a, 21b, 214c . . . ) respectively operate, the embedded module 102a can perform several functions, for instance shown in FIG. 1, Through the host and root hub unit 208, 210 to deliver or receive at least an operational signal from or to the set of keyboard, mouse of the console 106, or through the device controller unit 212 and the hub unit 214, to deliver or receive at least an operational signal from or to the computers 120 and peripherals 116, respectively. Furthermore, the GPIO unit 216 can send the such signals to other output unit, like a LED lamp, buzzer or speaker installed in the KVM switch or outside the KVM switch so as to indicate a warning, alert or other purposes. The inter-integrated circuit (I₂C) unit 218 is a two-wire serial interface to transmit data from or to the devices of the computers or the peripherals, e.g. a fan or cooling unit. And, the transmitted data could be a temperature, a monitored result for specific hardware components. etc. The video process unit 220 can deliver or receive at least one operational signal from or to the computers 114 and the console 110 as indicated in FIG. 1. The phase lock loop (PLL) 222 is a common-used part for the clock synchronization of the integrated circuit. The serial transmission port control unit 224 is coupled to an upgrade port (not shown) of KVM switch 100 to download new update control instructions from the provider via Internet. The new update control instructions must be proceed by the decoder 204 and the core unit 202, and then stored into the first storage block 304 of the first memory 308. In practice, the upgrade port of KVM switch 100 can be a Universal Asynchronous Receiver Transmitter (UART), such a RS-232 data receiving/transmitting port. The bus 226 is a channel to transmit data in the embedded module 102a.

The claimed invention is able to download encoded new control instructions into the first storage block 304 by executing the upgrade instructions stored in the second storage block 306 to keep the design information of the KVM switch confidential. Moreover, because the system on chip is not embedded with Flash ROM inside so that the control instructions of software are encoded, and the design of the keyboard-video-mouse (KVM) switch can be customized actively and cost down will also be the benefit of customization.

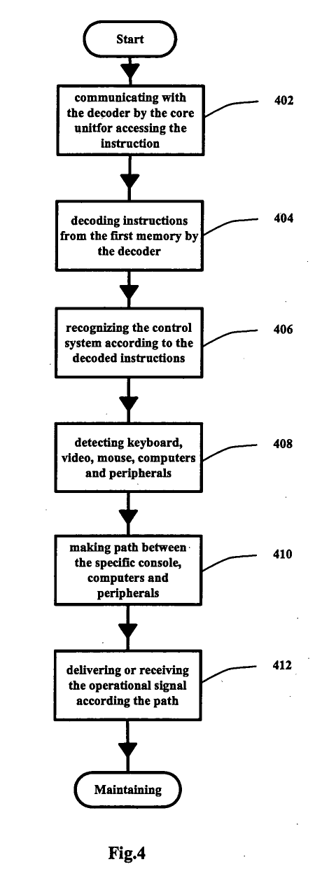

Please refer to FIG. 4. It shows a flow chart of the method according to the present invention, to perform a control system for controlling a keyboard-video-mouse (KVM) switch, comprising the following steps. In step 402, the core unit communicates with the decoder for accessing the instruction in the first memory via the decoder. In step 404, the decoder decodes the instructions from the first memory and fetches the instructions by the core unit. In step 406, the embedded module recognizes the control system according to the decoded instructions accessed from the first memory. In step 408, the embedded module detects whether the at least one set of keyboard, video, mouse of at least one console, a plurality of computers, and several peripherals is alive or not. In step 410, the core unit makes at least one path between specific set of keyboard, video, mouse of a console, specific computers and specific peripherals according to the command from the console on demand. In step 412, the KVM switch delivers and receives the at least an operational signal from or to the specific set keyboard, video, mouse of the console, the specific computers and the specific peripherals, simultaneously using the second memory as buffer to keep the data transmission.

In conclusion, the proposed invention is to provide a control system and method for controlling a keyboard-video-mouse (KVM) switch that the embedded module (system on chip) is not embedded with Flash ROM therein to encode the control instructions so that the design of the keyboard-video-mouse (KVM) switch can be customized actively and the design of the proposed control system and method is able to be complied with various kinds of data transmission specifications.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A control system for controlling a keyboard-video-mouse (KVM) switch interconnecting among at least one set of keyboard, video, mouse of a console and a plurality of computers, the control system comprising:
a first memory, storing a plurality of control instructions to control operational signals for the keyboard-video-mouse switch;
at least one embedded module, comprising:
a core unit, executing the control instructions fetched from the first memory to control the keyboard, video, mouse signals from or to the keyboard-video-mouse switch;
a second memory, accessed by the core unit to load and store at least an operational signal through a communication among the console and the computers; and
a decoder coupled to the core unit and the first memory respectively to decode the control instructions stored in the first memory.

2. The control system of claim 1, wherein the operational signals includes a keyboard, video, or mouse signal.

3. The control system of claim 2 wherein the embedded module is designed to be a system on chip (SoC).

4. The control system of claim 3, wherein the embedded module further comprises a host controller unit applied with a root hub unit to deliver or receive the operational signal from either the keyboard or the mouse of the console.

5. The control system of claim 4, wherein the embedded module further comprises at least one device controller unit used to deliver or receive the operational signal for either the keyboard or the mouse to and from the computers.

6. The control system of claim 5, wherein the embedded module further comprises at least one hub unit used to deliver or receive the operational signal to and from at least one of peripherals.

7. The control system of claim 6, wherein the embedded module further comprises a video processor unit used to receive the operational signal from the computers and deliver the operational signal to the console.

8. The control system of claim 7, wherein the embedded module further comprises at least one general purpose input and output (GPIO) unit used to transfer the operational signal among the peripherals and the control system.

9. The control system of claim 8, wherein the embedded module further comprises at least one inter-integrated circuit (I₂C) unit used to transfer the operational signal among the peripherals and the control system.

10. The control system of claim 1, wherein the first memory comprises a first storage block and a second storage block.

11. The control system of claim 10, wherein the first storage block of the first memory is used to store the control instructions.

12. The control system of claim 10, wherein the second storage block of the first memory is used to store an upgrade instructions.

13. The control system of claim 12, wherein the upgrade instructions are encoded, then stored in the second storage block of the first memory.

14. The control system of claim 1, wherein the embedded module further comprises a serial transmission port control unit to coupled to the core unit so that it is capable to download new control instructions through the serial transmission port control unit into the first storage block of the first memory.

15. The control system of claim 14, wherein the core unit can execute the upgrade instructions stored in the second storage block of the first memory to download the new control instructions into the first storage block.

16. The control system of claim 15, wherein the new control instructions are pre-encoded and then stored into the first storage block of the first memory.

17. The control system of claim 1, wherein the at least an embedded module can be set at either a master mode or slave mode whereby an embedded module with master mode is able to control the other embedded module with slave mode.

18. The control system of claim 17, further comprises a control process unit used to control the embedded modules.

19. The control system of claim 18, wherein each of the at least embedded module is set at the slave mode.

20. A control system for controlling keyboard-video-mouse (KVM) switch to connect at least one set of keyboard, video, mouse of a console with a plurality of computers, the control system comprising:
at least one embedded module, comprising:
a core unit, executing the control instructions fetched from the first memory to control the keyboard, video, mouse signals from or to keyboard-video-mouse switch;
a second memory, accessed by the core unit to load and store operational data through communication among the console and, the computers; and
a first memory, storing a plurality of control instructions to control keyboard, video, mouse signals for keyboard-video-mouse switch.
a decoder coupled to the core unit and the first memory respectively to decode the control instructions stored in the first memory.

21. A method of performing a control system for controlling a keyboard-video-mouse (KVM) switch interconnecting among at least one set of keyboard, video, mouse of at least one console, and a plurality of computers and having a first memory and at least one embedded module including a core unit, a second memory and a decoder, the method comprising the steps:
Initializing the control system by the embedded module;
the embedded module detecting whether the at least one set of keyboard, video, mouse of at least one console, a plurality of computers alive or not; and
transferring at least an operational signal among at least one set keyboard, video, mouse of at least one console, and a plurality of computers.

22. The method of claim 21, wherein the initializing step comprising:
communicating with the decoder by the core unit;
decoding instructions from the first memory by the decoder; and
recognizing the control system according to the decoded instructions accessed from the first memory by the embedded module.

23. The method of claim 21, wherein the transferring step comprising:
making at least one path between specific set of keyboard, video, mouse of a console, specific computers and specific peripherals according to the command from the console;
delivering or receiving the at least an operational signal from or to the specific set keyboard, video, mouse of a console, the specific computers and the specific peripherals simultaneously using the second memory as buffer according the path by the core unit.
